(19) United States
(12) Patent Application Publication
(10) Pub. No.: US 2010/0095706 A1
(43) Pub. Date: Apr. 22, 2010

(54) Method for manufacturing optical fibers and optical fiber performs

(76) Inventor: Mohammed Saad, Ile Des Soeurs (CA)

Correspondence Address: Louis Tessier, C.P. 54029, Mount-Royal, QC, H3P 3H4, CA

(21) Appl. No.: 12/588,568

(22) Filed: Oct. 20, 2009

Related U.S. Application Data
(60) Provisional application No. 61/136,972, filed on Oct. 20, 2008.

(51) Int. Cl. C03C 3/32

(52) U.S. Cl. 65/388

(57) ABSTRACT

A method of manufacturing an optical fiber preform, the method comprising: providing a substantially elongated core preform made out of a core fluorinated glass; providing a substantially elongated and substantially tubular cladding preform made out of a cladding fluorinated glass, the cladding preform defining a bore extending substantially longitudinally therethrough; inserting the core preform into the bore of the cladding preform; fusing the core preform and the cladding preform to each other to produce an intermediate preform; heating the intermediate preform up to a stretching temperature, the stretching temperature being such that the core and cladding fluorinated glasses both have a viscosity of between 10⁻⁷ and 10⁻⁹ Pa s at the stretching temperature; stretching the intermediate preform at the stretching temperature to produce a stretched intermediate preform; and cutting a section of the stretched intermediate preform. Typically, the stretching temperature is between a vitreous transition temperature and a crystallization temperature of the core and cladding glasses.

The present application claims priority from U.S. Provisional Patent Application Ser. No. 61/136,972 filed on Oct. 20, 2008.

### FIELD OF THE INVENTION

The present invention relates to optical components. More specifically, the present invention is concerned with a method for manufacturing optical fibers and optical fiber preforms.

### BACKGROUND

There are many existing methods for manufacturing optical fibers. For example, in the so-called built-in casting method, molten glass is poured into a mold. The mold includes a bottom aperture that is selectively openable and closable. At first, the glass is poured into the mold with the aperture closed. After a cooling period, most of the glass that has been poured into the mold is solidified, except for a relatively small amount of glass at the center of the mold. Then, the aperture is opened to let the molten glass contained in the mold exits the mold. Afterwards, the aperture is once again closed and another glass is poured into the central cavity thereby formed.

Therefore, it is possible in this manner to manufacture a preform for manufacturing an optical fiber. However, it is relatively difficult to achieve small dimensions at the center of the mold when the glass located at the center is let go through the aperture. Therefore, it is relatively difficult to manufacture preforms that usable to manufacture optical fibers having relatively small cores, such as single mode fibers, using in this technique.

In another technique called rotational casting, a substantially cylindrical mold is disposed substantially horizontally and molten glass is poured into the mold gradually. The mold is rotated about its longitudinal axis as the glass is poured thereinto and, therefore, the glass solidifies gradually at the periphery of the mold. By carefully selecting the rotation speed and rate of glass pouring into the mold, it is possible to manufacture a preform having a substantially tube like configuration. Then, a glass rod is inserted through the central aperture to manufacture the optical fiber preform. Once again, it is relatively difficult to manufacture optical fibers having relatively small cores using this technique.

Many other techniques exist for manufacturing optical fiber preforms. For example, in one such technique, a mold includes a reservoir from which a substantially tubular pipe extends upwardly. The reservoir and the pipe are filled with a first glass which is then cooled gradually. Since the glass contracts as it cools, because of the tubular configuration of the tube, a substantially cylindrical central aperture is formed in the solidifying glass during the cooling process within the pipe. Then, another glass can be poured into the central aperture to manufacture a preform that is then stretched to form an optical fiber. While this technique is usable to manufacture monomode fibers, it is relatively difficult to perform consistently and to achieve preforms having suitable optical properties for manufacturing optical fibers using this technique.

In yet another technique for manufacturing monomode optical fibers, a rod of a core glass is inserted inside a tube of a cladding glass. The central aperture of the tube is slightly larger than the diameter of the rod. Then, the whole assembly is heated to collapse the tube onto the core. Once again, this technique gives relatively poor results when manufacturing monomode optical fibers.

In yet another technique described in U.S. Pat. No. 6,574,994 issued Jun. 10, 2003 to Cain et al, a rod made of core glass is first inserted into a tube of cladding glass. The rod and the tube are substantially similar to the rod and tube used in above-described methods for manufacturing preforms for optical fibers. Then, the core and tube are fused to each other and stretched by a first amount. Afterwards, the core and tube are then cut into pieces and the core and tube assembly is inserted into another tube of cladding glass. The second assembly is then stretched to form the optical fibers. In this manner, optical fibers having relatively small cores are relatively easily manufactured. However, it is believed that this technique is not well suited to manufacturing of many types of optical fibers such as, for example, heavy metal fluoride glasses containing optical fibers.

Indeed, these optical fibers are typically very sensitive to heating and cooling steps as they are relatively unstable and can therefore create crystals when repeatedly heated and cooled. These crystals, when present into optical fibers, introduce defects that greatly affect the optical performance of the optical fibers. These problems are mentioned for example in Journal of non-crystalline solids 213&214 (1997) pp 90-94, which is hereby incorporated by reference in its entirety. Therefore, it would seem that the method described in Cain et al is not well suited for the manufacturing of monomode optical fibers using heavy metal fluoride glasses and other similar unstable glasses.

Against this background, there exists a need in the industry to provide novel methods for manufacturing optical fibers and optical fiber preforms. An object of the present invention is therefore to provide improved methods for manufacturing optical fibers and optical fiber preforms.

### SUMMARY OF THE INVENTION

In a first broad aspect, the invention provides a method of manufacturing an optical fiber preform, the method comprising: providing a substantially elongated core preform made out of a core fluorinated glass; providing a substantially elongated and substantially tubular cladding preform made out of a cladding fluorinated glass, the cladding preform defining a bore extending substantially longitudinally therethrough; inserting the core preform into the bore of the cladding preform; fusing the core preform and the cladding preform to each other to produce an intermediate preform; heating the intermediate preform up to a stretching temperature, the stretching temperature being such that the core and cladding fluorinated glasses both have a viscosity of between 10⁻⁷ and 10⁻⁹ Pa s at the stretching temperature; stretching the intermediate preform at the stretching temperature to produce a stretched intermediate preform; and cutting a section of the stretched intermediate preform. Typically, the stretching temperature is between a vitreous transition temperature and a crystallization temperature of the core and cladding glasses.

In some embodiments of the invention, the core and cladding fluorinated glasses each include a base substance selected from the group consisting of ZrF₄, HfF₄, GaF₃ and InF₃. The base substance is a molecule that has a highest molar concentration in the glass. Other substances are added in the glass to obtain desired physicochemical characteristics in accordance with methods well-known in the art.

For example, the core and cladding fluorinated glasses each include from 40% to 60% molar of a combination of ZrF₄ and HfF₄ or from 35% to 45% molar of a combination of GaF₃ and InF₃. These compositions allow to achieve flow characteristics of the glasses at temperatures suitable for performing the proposed method.

In some embodiments of the invention, the method further includes providing a substantially elongated outer cladding preform made out of the cladding fluorinated glass, the outer cladding preform defining an outer preform bore extending substantially longitudinally therethrough; polishing the section of the stretched intermediate preform; inserting the section of the stretched intermediate preform in the outer preform bore; and fusing the section of the stretched intermediate preform and the outer cladding preform to each other.

In some embodiments of the invention, the cladding preform is collapsed around the core preform prior to fusing the cladding preform and the core preform to each other.

In another broad aspect, the invention provides a method of manufacturing an optical fiber, the method comprising stretching an optical fiber preform manufactured as described hereinabove at a fiber stretching temperature, the fiber stretching temperature being such that the core and cladding fluorinated glasses both have a viscosity of between 10⁻⁵ and 10^{-∂}Pa s at the stretching temperature.

Providing the preforms can either be performed by buying or manufacturing a preform in accordance with known processes.

Advantageously, the proposed method is usable to relatively easily manufacture optical fibers having relatively small cores such as, for example, monomode or few mode fibers. It has been found that, surprisingly, using suitable parameters, the above method may be used using many types of glasses that are typically affected by repetitive heating and cooling processes. For example, the above method has been shown to work satisfactorily using heavy metal fluoride glasses. However, this method is also usable for any glass having a relatively low fusion temperature and viscosity. It has been shown that the above method advantageously produces optical fibers that have a relatively good optical properties and for which the core has relatively good eccentricity and cylindricity. It has been shown also that with this method we have a relatively good control of the core diameter along hundreds of meter of fiber.

Other objects, advantages and features of the present invention will become more apparent upon reading of the following non-restrictive description of preferred embodiments thereof, given by way of example only with reference to the accompanying drawings.

### BRIEF DESCRIPTION FOR DRAWINGS

In the appended drawings:

FIG. 1, in a schematic view, illustrates a method for manufacturing an optical fiber in accordance with an embodiment of the present invention; and

FIG. 2, in a X-Y graph, illustrates an index of refraction profile obtained using a specific embodiment of the method illustrated in FIG. 1.

### DETAILED DESCRIPTION

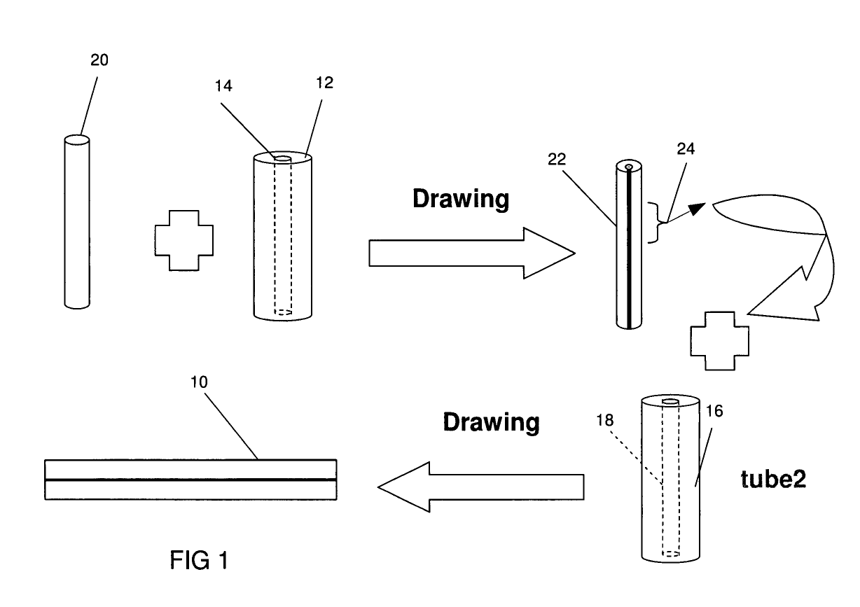

FIG. 1 illustrates, in a schematic view, a method in accordance with the present invention. Briefly, the method includes repetitively inserting rod-shaped preforms into a substantially tubular preform made of a cladding material. Then, the rod-shaped preform and the tubular preform are fused to each other and stretched to form another preform that is usable with another tubular preform to repeat the process or, when stretched to a relatively large extension, to form an optical fiber.

More specifically, the method uses substantially elongated and substantially tubular cladding preforms 12 and 16, each made out of a cladding fluorinated glass. The cladding fluorinated glass is a glass that is forming the cladding of an optical fiber when the method has been completed. The cladding preform 12 is referred to as the inner cladding preform 12 and the cladding preform 16 is referred to as the outer cladding preform 16 for reasons that will become clear hereinbelow. The inner and outer cladding preforms 12 and 16 have substantially similar compositions if a 1-cladding fiber is desired, and different compositions if a multi-cladding fiber is desired.

The cladding preforms 12 and 16 each define a respective bore 14 and 18 extending substantially longitudinally therethrough, which typically has a substantially cylindrical configuration. The method also uses a substantially elongated core preform 20, typically having a substantially cylindrical configuration, and made out of a core fluorinated glass. The core fluorinated glass is a material that makes the core of an optical fiber manufactured according to the invention.

First, the core preform 20 is inserted into bore 14 of the inner cladding preform 12. Subsequently, the core preform 20 and the inner cladding preform 12 are fused to each other, thereby forming an intermediate preform 22. In some embodiments, prior to fusing, the inner cladding preform is collapsed around the core preform 20, for example if the bore 14 has a diameter that differs to a relatively great extent from that of the inner cladding preform 12. Afterwards, in some embodiments of the invention, the intermediate preform 22 is polished, stretched and cut to produce a section of a stretched intermediate preform. This section of the stretched intermediate preform 24 is then inserted into the bore 18 of the outer cladding preform 16, thereby forming an optical fiber preform 24, which is stretched to form an optical fiber 10.

The reader skilled in the art will readily appreciate that, while the above-described method includes two general stages of stretching, it is within the scope of the invention to have more or less than two stages of stretching. Typically, the final stretching stage includes stretching the rod over a length of many thousand times its initial length. The other stretching stages are typically performed by stretching from about twice to about five times the rods.

During any stretching stage resulting in manufacture of an optical fiber preform, such as the intermediate preform 22, it has been found that heating the preform to stretch to a stretching temperature that is between the vitreous transition temperature and the crystallization temperature of the glasses used provides optimal results. The stretching operation is performed at this stretching temperature, typically under tension in a drawing tower. It has been found that stretching temperatures such that the core and cladding fluorinated glasses both have a viscosity of between 10⁻⁷ and 10⁻⁹ Pa s at the stretching temperature provides optimal results. The drawing temperature is typically 5 to 20 C lower than that used to draw multimode fibers with the same glass composition. The inventors have found that these operations are surprisingly achievable even for fluorinated glasses, which was believed to be impossible to perform. The stretching rate is selected according to known methods. In the final stage, resulting in the optical fiber 10, stretching temperatures such that the core and cladding fluorinated glasses both have a viscosity of between 10⁻⁵ and 10⁻⁷ Pa s at the stretching temperature provides optimal results.

In some embodiments of the invention, the core and cladding fluorinated glasses each include a base substance selected from the group consisting of ZrF₄, HfF₄, GaF₃ and InF₃. The base substance is a molecule that has a highest molar concentration in the glass. Other substances are added in the glass to obtain desired physicochemical characteristics in accordance with methods well-known in the art. For example, the core and cladding fluorinated glasses each include from 40% to 60% molar of a combination of ZrF₄ and HfF₄ or from 35% to 45% molar of a combination of GaF₃ and InF₃.

In alternative embodiments of the invention, the core preform 20 is not made entirely of the core fluorinated glass but is instead already a core/cladding glass structure, which may be manufactured according to any suitable method, such as for example built in casting.

### Example 1

An optical fiber 10 was formed using glasses having these compositions:

Cladding Fluorinated Glass:

53% ZrF₄; 20% BaF₂; 20% NaF; 4% LaF₃; and 3% AlF₃

Core Fluorinated Glass:

53% ZrF₄; 16% BaF₂; 20% NaF; 4% LaF₃; 3% AlF₃; and 4% PbF₂.

All percentages are molar percentages, in this and other examples. In this example, the core preform 20 and the inner cladding preform 12 had dimensions such that a ratio between the diameters of the core preform 20 and of the cladding preform was about 0.85. Then, the resulting intermediate preform 22 was polished and stretched until a rod of about 3 mm in diameter has been obtained using a drawing tower. Afterwards, an outer cladding preform 16 having inner diameter to outer diameter ratio of 0.27 and an outer diameter of 11.5 mm and an internal diameter of 3.1 mm was used to receive a section of the intermediate preform 24 thereinto and the resulting assembly was stretched until a rod of a diameter of 3 mm was obtained, and this second intermediate preform was once again inserted into a cladding preform 16 having an outer diameter of 11.5 mm and an internal diameter of 3.1 mm. Then, stretching allowed to manufacture an optical fiber having a diameter of 125 microns with a core diameter of 7.25 microns. The drawing speed was of 15 m/min. In all steps, the drawing temperature was maintained between 280 and 325 C.

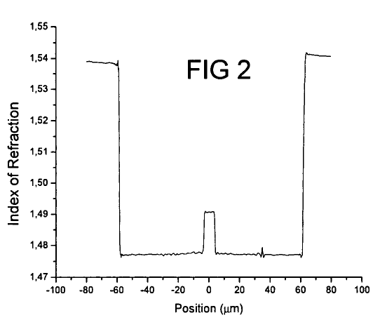

As seen in FIG. 2, this method produced an optical fiber having a relatively well-defined core/cladding transition and relatively homogeneous core and cladding indices of refraction.

### Example 2

An optical fiber 10 similar to that of Example 1 was manufactured with a 9 microns core and 125 microns cladding, all other parameters remaining similar to those of Example 1. Mechanical testing showed that the resulting optical fiber 10 had a 90 kpsi tensile strength and optical testing showed that the resulting fiber was of excellent optical quality with the ability to deliver at least 11.5 W in continuous wave mode at 1064 nanometers.

### Example 3

An optical fiber 10 was formed using glasses having these compositions:

Cladding Fluorinated Glass:

57% ZrF₄; 34% Ba F₂; 6% LaF₃; and 3% AlF₃

Core Fluorinated Glass:

57% ZrF₄; 31% BaF₂; 6% LaF₃; 3% AlF₃; and 3% PbF₂.

The fiber manufacturing process was similar to that described hereinabove, with a difference that the drawing temperature was maintained between 290 and 295 C. The drawing speed was of 2 to 3 mm/min for the first steps and 15 to 20 m/min for the last, fiber drawing, step. Once again, an optical fiber of suitable optical quality was obtained.

### Example 4

An optical fiber 10 was formed using glasses having these compositions:

Cladding Fluorinated Glass:

39.5% ZrF₄; 18% BaF₂; 22% NaF; 4% LaF₃; 13.5% HfF and 3% AlF₃

Core Fluorinated Glass:

53% ZrF₄; 20% BaF₂; 20% NaF; 4% LaF₃; and 3% AlF₃

The fiber manufacturing process was similar to that described hereinabove in example 2, with similar temperatures and drawings speeds. Once again, an optical fiber of suitable optical quality was obtained.

While only a few examples of optical fiber manufacturing have been described, it is hypothesized, based on known physicochemical characteristics of fluorinated glasses, that successful manufacturing of optical fiber and optical fiber proforms with other compositions, such as those including core and cladding fluorinated glasses that contain from 40% to 60% molar of a combination of ZrF₄ and HfF₄ or from 35% to 45% molar of a combination of GaF₃ and InF₃, among other possibilities, would be also successful.

Although the present invention has been described hereinabove by way of preferred embodiments thereof, it can be modified, without departing from the spirit and nature of the subject invention as defined in the appended claims.

What is claimed is:

1. A method of manufacturing an optical fiber preform, the method comprising:
providing a substantially elongated core preform made out of a core fluorinated glass;
providing a substantially elongated and substantially tubular cladding preform made out of a cladding fluorinated glass, said cladding preform defining a bore extending substantially longitudinally therethrough;
inserting said core preform into said bore of said cladding preform;
fusing said core preform and said cladding preform to each other to produce an intermediate preform;
heating said intermediate preform up to a stretching temperature, said stretching temperature being such that said core and cladding fluorinated glasses both have a viscosity of between 10⁻⁷ and 10⁻⁹ Pa s at said stretching temperature;
stretching said intermediate preform at said stretching temperature to produce a stretched intermediate preform; and
cutting a section of said stretched intermediate preform.

2. A method as defined in claim 1, wherein said core and cladding fluorinated glasses each include base substance selected from the group consisting of ZrF₄, HfF₄, GaF₃ and InF₃.

3. A method as defined in claim 2, wherein said wherein said core and cladding fluorinated glasses each include from 40% to 60% molar of a combination of ZrF₄ and HfF₄.

4. A method as defined in claim 2, wherein said wherein said core and cladding fluorinated glasses each include from 35% to 45% molar of a combination of GaF₃ and InF₃.

5. A method as defined in claim 1, further comprising:
providing a substantially elongated outer cladding preform made out of said cladding fluorinated glass, said outer cladding preform defining an outer preform bore extending substantially longitudinally therethrough
polishing said section of said stretched intermediate preform;
inserting said section of said stretched intermediate preform in said outer preform bore; and
fusing said section of said stretched intermediate preform and said outer cladding preform to each other.

6. A method as defined in claim 1, further comprising collapsing said cladding preform around said core preform prior to fusing said cladding preform and said core preform to each other.

7. A method as defined in claim 1, wherein said stretching temperature is between a vitreous transition temperature and a crystallization temperature of said core and cladding glasses.

8. A method of manufacturing an optical fiber, said method comprising stretching an optical fiber preform as defined in claim 4 at a fiber stretching temperature, said fiber stretching temperature being such that said core and cladding fluorinated glasses both have a viscosity of between 10⁻⁵ and 10⁻⁷ Pa s at said stretching temperature.
